(19) United States
(12) Patent Application Publication
(10) Pub. No.: US 2006/0099397 A1
(43) Pub. Date: May 11, 2006

(54) Ceramic moulded body comprising a photocatalytic coating and method for producing the same

(75) Inventors: Axel Thierauf, Mallersdorf-Pfaffenberg (DE); Eduard Gast, Kraiburg (DE); Friederike Bauer, Bernhardswald (DE)

Correspondence Address: SYNNESTVEDT LECHNER & WOODBRIDGE LLP, P O BOX 592, PRINCETON, NJ, 08542-0592, US

(73) Assignee: Erlus Aktiengesellschaft, Neufahrn (DE)

(21) Appl. No.: 10/516,642

(22) PCT Filed: May 28, 2003
(86) PCT No.: PCT/DE03/01741

§ 371 Date: Sep. 12, 2005

(30) Foreign Application Priority Data
May 29, 2002 (DE) 102 24 110.4

(51) Int. Cl. B32B 3/00; B32B 3/26; B05D 3/02; B29C 71/04; B05D 1/12

(52) U.S. Cl. 428/312.2; 428/312.6; 264/601; 427/372.2; 427/532; 427/180

(57) ABSTRACT

The invention relates to a ceramic moulded body, namely a roof tile, a brick, a clinker or a facade wall, consisting of an oxide ceramic base material and comprising a surface which self-cleans by means of water-sprinkling or percolation. Said moulded body has a porous, oxide ceramic coating which is photocatalytically active and has a specific surface of between approximately 25 m²/g and approximately 200 m²/g, preferably between approximately 40 m²/g and approximately 150 m²/g. The invention also, relates to a method for producing one such ordinary ceramic moulded body.

The invention concerns a ceramic molded body of oxide-ceramic base material with a surface which is self-cleaning upon spraying or sprinkling with water and a process for the production thereof.

EP 0 590 477 B1 discloses a building material which can be for example an outside wall material or roof material, wherein a thin metal oxide film with a photocatalytic action is applied on the surface of the building material. The metal oxide film is preferably applied by means of sol-gel processes. A titanium dioxide thin film building material is preferably produced using titanium dioxide sol. The thin metal oxide film known from EP 0 590 477 B1 has deodorosing anti-mold properties.

By virtue of its film-like structure the metal oxide film known from EP 0 590 477 B1 is of a small surface area and accordingly has a low level of catalytic activity.

DE 199 11 738 A1 discloses a titanium dioxide photocatalyst which is doped with Fe³⁺ ions and which has a content of pentavalent ions, which is equimolar or approximately equimolar in relation to the Fe³⁺ ions. The titanium dioxide photocatalyst known from DE 199 11 738 A1 and doped with Fe³⁺ ions is produced by way of sol-gel processes.

EP 0 909747 A1 discloses a process for producing a self-cleaning property of surfaces, in particular the surface of roof tiles, upon being sprayed or sprinkled with water. The surface has hydrophobic raised portions of a height of between 5 and 200 μm in distributed form. To produce those raised portions, a surface is wetted with a dispersion of powder particles of inert material in a siloxane solution and the siloxane is then hardened. The process known from EP 0 909 747 A1 makes it possible to produce a coarse-ceramic body having a surface to which particles of dirt can cling poorly. The ceramic body known from EP 0 909 747 A1 does not have any catalytic activity whatsoever.

WO 01/79141 A1 discloses a further process for producing a self-cleaning property of a surface and an article produced with that process. In accordance with that process, a metallorganic compound of titanium oxide is applied to a surface by means of a sol-gel process, the surface is dried and then subjected to heat treatment at elevated temperature. The surface of the titanium oxide layer can be subsequently hydrophobised.

The object of the present invention is to provide a coarse-ceramic molded body, in particular roof materials, facade panels and external facing bricks, which has an improved self-cleaning capability and improved stability such as for example improved resistance to abrasion.

A further object of the invention is to provide a process for the production of such an improved coarse-ceramic molded body.

The object of the invention is attained by a ceramic molded body, more specifically a roof tile, tile, clinker brick, facing brick, facade panel or a facade wall of oxide-ceramic base material with a surface which is self-cleaning upon spraying or sprinkling with water, wherein the molded body has a porous oxide-ceramic coating, wherein the coating is photocatalytically active and has a specific surface area in a range of between about 25 mg²/g and about 200 m²/g, preferably between about 40 m²/g and about 150 m²/g.

Preferred developments of the ceramic molded body are set forth in appendant claims 2 through 33.

The object of the invention is further attained by a process for the production of a coarse-ceramic molded body of oxide-ceramic base material with a capillary structure and with a surface which is self-cleaning upon spraying or sprinkling with water, wherein the molded body has a photocatalytically active, porous, oxide-ceramic coating with a specific surface area in a range of between about 25 m²/g and about 200 m²/g, preferably about 40 m²/g and about 150 m²/g, and the porous oxide-ceramic coating is disposed on the surface and in the pore openings and the free faces of the capillary structure near the surface in the interior of the coarse-ceramic molded body,

wherein the process includes the following steps:

(a) mixing photocatalytically active, oxide-ceramic powder, inorganic stabilisation agent and a liquid phase to afford a suspension,

(b) applying the suspension produced in step a) to the oxide-ceramic base material to produce a layer, and

(c) hardening the layer afforded in step (b) to produce a photocatalytically active, porous, oxide-ceramic coating.

Preferred developments of that process are recited in appendant claims 35 through 61.

The coarse-ceramic molded body produced using the process according to the invention involves a highly suitable porosity and stability.

Unlike the sol-gel processes preferably used in the state of the art for the production of coatings, in accordance with the invention a suspension of photocatalytically active, oxide-ceramic powder with further components is applied to an oxide-ceramic base material. The photocatalytically active, oxide-ceramic particles or the photocatalytically active, oxide-ceramic powder have or has a high porosity, that is to say specific surface area. Accordingly that does not involve the production of a film but the production of a porous structure with a large specific surface area.

The coatings of titanium oxide which are produced using sol-gel processes on substrates of the most widely varying kinds are dense, closed and optically transparent films. A coarse ceramic such as for example a roof tile has a specific surface area of less than 1 m²/g. Consequently a TiO₂ coating applied to a roof tile using a sol-gel process also has a specific surface area of less than 1 m²/g.

The coarse ceramics produced in accordance with the invention and provided with a photocatalytically active coating have an incomparably higher specific surface area in a range of between about 25 m²/g and about 200 m²/g.

This extraordinarily high specific surface area is achieved in accordance with the invention by a procedure whereby particles, for example particulate TiO₂, are applied to the substrate to be coated. When applying particulate TiO₂—unlike applying TiO₂ by means of gel-sol processes—it is not a closed film but a textured coating or structure with a large specific surface area that is applied. In addition the porosity of the TiO₂ particles which are used by way of example also contributes substantially to the high specific surface area of the porous, oxide-ceramic coating of the ceramic or coarse ceramic according to the invention.

In the case of a coarse ceramic, for example a roof tile, coated with TiO₂ particles according to the invention, the TiO₂ particles on the surface of the coarse ceramic result in a light scattering effect which makes itself noticeable in the visible range by virtue of the fact that the coarse ceramic has a blueish/violet iridescence. That optical effect is presumably to be attributed to the Tyndall effect. In other words, the red color shade of a calcined coarse ceramic, for example a clay roof tile, is displaced more in the direction of dark red or brownish red, for a viewer.

The structure produced is a highly porous structure, that is to say the specific surface area of the catalytically active, porous, oxide-ceramic coating is in a range of between 25 m²/g and 200 m²/g, further preferably in a range of between about 40 m²/g and about 150 m²/g. More preferably the specific surface area is in a range of between 40 m²/g and about 100 m²/g.

The catalytically active, porous, oxide-ceramic coating is applied both to the surface of the ceramic or coarse ceramic and also in the capillary structure. In other words, the pore openings and the free faces in the capillary tubes are provided with the catalytically active, porous, oxide-ceramic coating. In that respect the coating is preferably applied to a depth of about 1 mm in the capillary structure which is immediately under the surface of the coarse-ceramic molded body, preferably with a uniform distribution of the particle sizes and kinds of particles. Preferably the operation of applying the coating is to a depth of about 1 mm, possibly further preferably to a depth of 2 mm. In that respect the depth is specified in a vertical direction, with respect to the surface of the molded body, into the interior thereof.

In accordance with a preferred development the free breathing cross-section of the ceramic or coarse-ceramic molded body is reduced by the applied porous, oxide-ceramic coating by less than 10%, preferably less than 5%, with respect to the free breathing cross-section of an uncoated ceramic or coarse-ceramic molded body.

In a further preferred feature the free breathing cross-section is reduced by less than about 2%, still further preferably by less than about 10%.

The mean diameter of the pores or capillaries of a coarse ceramic is usually in a range of between 0.1 μm and 5 μm, preferably between 0.1 μm and 0.3 μm.

The ceramic, that is to say the roof tile, tile, clinker brick, facing brick, facade panel or facade wall, or the coarse ceramic produced by way of the process according to the invention, accordingly extremely advantageously has a photocatalytically active coating in the pore structure so that soiling and contamination deposited in the pores is effectively oxidised and is easily flushed out subsequently when subjected to spraying or sprinkling.

As the pore structure of the coarse ceramic is not substantially constricted by the applied coating, the particles of dirt can be readily flushed out of the pores.

Accordingly even after prolonged use, in particular under natural environmental and weathering conditions, the coarse ceramic according to the invention has a clean and attractive appearance by virtue of the improved self-cleaning property.

With a specific surface area of about 50 m²/g a highly satisfactory catalytic activity in respect of the applied oxide-ceramic coating is achieved. In that respect the mean layer thickness of the oxide-ceramic coating is preferably in a range of between about 50 nm and about 50 μm, further preferably between about 100 nm and about 1 μm. In that respect the layer is produced not just in the pores or capillaries of the surface but also on the surface of the coarse-ceramic molded body. In that way it is possible partially to produce layer thicknesses for the oxide-ceramic coating, which are greater than the mean diameter of the pores or capillaries which are usually in a range of between 0.1 μm and 5 μm. A highly satisfactory catalytic activity is obtained with a layer thickness of about 1 μm.

The photocatalytically active, porous, oxide-ceramic coating according to the invention provides that mold, fungal and plant growth, for example moss, algae etc, bacterial contamination etc, which are deposited on or in the coarse-ceramic molded body are photochemically broken down and removed. The photocatalytic activity of the porous, oxide-ceramic coating is adequate at ambient temperature to oxidise and thus break down the stated substances and contamination. The oxidised substances have a reduced adhesion capability and are easily flushed off the surface of the molded body according to the invention when subjected to the action of spray or sprinkling with water.

It is assumed that the photocatalytically active coating can have an oxidative action on the one hand directly on the organic contamination and impurities. On the other hand it is assumed that the oxidative effect of the photocatalytically active coating is effected indirectly by the production of oxygen radicals which subsequently oxidise and accordingly break down the contaminating substances or impurities.

The self-cleaning action of the ceramic molded body according to the invention or the coarse-ceramic molded body produced by way of the process according to the invention can be further enhanced if a surface structure with raised portions or depressions is arranged under the photocatalytically active, porous, oxide-ceramic coating and/or if the photocatalytically active, porous, oxide-ceramic coating itself has a surface structure with raised portions and recesses.

It has been found that coarse-ceramic surface structures with raised portions, preferably involving a predetermined distribution density, have a surprising self-cleaning property. The raised portions can also be hydrophobised so that the adhesion of hydrophilic soiling substances or contaminants is further greatly reduced.

The raised portions can be formed by the application of particulate material to the oxide-ceramic base material. In that respect preferably temperature-resistant crushed material is used as the particulate material, preferably selected from the group which consists of crushed stone, fire clay, clay, minerals, ceramic powder such as SiC, glass, glass chamotte, and mixtures thereof.

The term temperature-resistant material is used in accordance with the invention to denote that the material does not soften at a temperature of preferably up to 1100° C., further preferably up to 600° C.

It will be appreciated that TiO₂, Al₂O₃, SiO₂, and/or Ce₂O₃ can be used as the particulate material. In that respect particles of a size in a range of up to 1500 nm, preferably between about 5 nm and about 700 nm, have proven to be highly suitable. In addition a particle size range of between about 5 nm and about 25 to 50 nm is highly preferred.

It is preferred that the raised portions or recesses are of heights or depths respectively in a range of up to 1500 nm, preferably between about 5 nm and about 700 nm, further preferably between about 5 nm and about 25 to 50 nm. In that way the raised portions can also be formed with the aggregation or agglomeration of smaller particles.

In that respect the particulate material can be fixed to the oxide-ceramic base material using adhesives. For example the adhesives used can be polysiloxanes which on the one hand fix the particulate material to the surface of the oxide-ceramic base material and on the other hand provide the produced coating with a superhydrophobic surface. The adhesive, for example the polysiloxane, is added in step (a) of the process according to the invention in production of the suspension. If hydrophobisation of the surface of the coating is to be maintained, in that case the hardening operation in step (c) is not to be effected at a temperature of more than 300° C. If the temperature is increased above 300° C., that can involve thermal decomposition of the polysiloxane and the breakdown of the superhydrophobic surface on the photocatalytically active, porous, oxide-ceramic coating.

It is not necessary however with the present invention to use adhesives for fixing particulate material, for example photocatalytically active, oxide-ceramic particles. The particles can also be joined to the oxide-ceramic base material by a sinter-like connection. For example the particles can be applied in the form of a suspension to the oxide-ceramic base material and then the whole can be heated to a temperature of between about 200° C. and 500° C., preferably about 300° C. In that way the particles are reliably secured to the coarse ceramic or ceramic.

When calcining the coarse-ceramic molded body which is usually effected in a range of between more than 300° C. and about 1100° C., the particulate material used for producing raised portions is subjected to the action of a temperature which results in superficial softening of the particle surfaces so that a sinter-like join is produced between the particulate material and the oxide-ceramic base material. In that respect it is for example also possible to add fluxing agents which reduce the sintering temperature.

The man skilled in the art is aware from EP 0 909 747, EP 00 115 701 and EP 1 095 023 of various possible ways of fixing particulate material on a ceramic surface. The contents of EP 0 909 747, EP 00 115 701 and EP 1 095 923 are hereby incorporated by reference thereto.

Preferably, the photocatalytically active, porous, oxide-ceramic coating is formed by using photocatalytically active, oxide-ceramic materials selected from the group consisting of TiO₂, Al₂O₃, SiO₂, Ce₂O₃ and mixtures thereof.

In accordance with a further preferred embodiment the above-mentioned photocatalytically active, oxide-ceramic materials may also be contained in the oxide-ceramic base body.

In accordance with a preferred embodiment the photocatalytically active, oxide-ceramic material in the coating and/or in the oxide-ceramic base material includes TiO₂ or Al₂O₃, optionally in combination with further oxide-ceramic materials. For example mixtures of titanium dioxide and silicon dioxide, titanium dioxide and aluminum oxide, aluminum oxide and silicon dioxide and also titanium dioxide, aluminum oxide and silicon dioxide have been found to be highly suitable.

In that respect preferably titanium dioxide with an anatase structure is used as the titanium dioxide. The aluminum oxide used is preferably aluminum oxide C which is to be allocated crystallographically to the δ-group and has a strong oxidation-catalytic effect.

A suitable aluminum oxide C can be obtained from Degussa AG, Germany. For example AEROSIL COK 84, a mixture of 84% AEROSIL 200 and 16% aluminum oxide C has proven to be very usable in the present invention.

When using TiO₂ in the oxide-ceramic coating it is preferable that the TiO₂ is present at least in part in the anatase structure, preferably in respect of at least 40% by weight, preferably in respect of at least 70% by weight, further preferably in respect of at least 80% by weight, with respect to the total amount of TiO₂.

TiO₂ which is present in a mixture of about 70-100% by weight anatase and about 30-0% by weight rutile has proven to be highly suitable.

In accordance with a further preferred development of the invention the TiO₂ is present in respect of about 100% in the anatase structure.

Preferably the TiO₂ used in the present invention is obtained by flame hydrolysis of TiCl₄ in the form of highly disperse TiO₂ which preferably has a particle size of between about 15 nm and 30 nm, preferably 21 nm.

By way of example, it is possible to use for that purpose the titanium dioxide which can be obtained under the name titanium dioxide P25 from Degussa AG, Germany and which comprises a proportion of 70% anatase form and 30% rutile. Extremely advantageously titanium dioxide in the anatase form absorbs UV light at wavelengths of less than 385 nm. Rutile absorbs UV light at a wavelength of less than 415 nm.

A surface of a coarse ceramic according to the invention, preferably a roof tile, which is coated with TiO₂ particles, has a superhydrophilic surface after 15-hour irradiation with 1 mW/cm² UV-A black light, which corresponds to about 30% of the solar radiation strength on a clear Summer's day.

A measurement in respect of superhydrophilia is the contact angle of a drop of water of a defined volume (here 10 μl). That drop is brought into contact with the surface to be investigated and photographed at time intervals of a second. Then for each recording both the left contact angle and also the right contact angle between the drop and the surface are calculated. The values hereinafter are respectively the mean value between the calculated contact values.

Firstly the contact angles were ascertained for a comparative roof tile without TiO₂ particle coating and two roof tiles A and B according to the invention. The three roof tiles were then irradiated for 15 hours with 1 mW/cm² UV-A black light. The respective contact angles ascertained are set forth in Table 1:

TABLE 1
Contact angle

| | Contact angle after | Contact angle after |
|---|---|---|
| Roof tile | 0 h irradiation | 15 h irradiation |
| Roof tile A acc. inv. | 19.2° | 4.0° |
| Roof tile B acc. inv. | 18.4° | <4.0° |
| Comparative roof tile | 29.8° | 27.3° |

After an irradiation time of 15 hours the roof tiles A and B according to the invention were stored in darkness over a period of 30 days. The contact angles determined after 30 days in darkness are specified in Table 2:

TABLE 2
Contact angle after 30 days in darkness

| | Contact angle after |
|---|---|
| Roof tile | 30 days in darkness |
| Roof tile A acc. inv. | 17.1° |
| Roof tile B acc. inv. | 13.6° |

After 30 days in darkness roof tiles A and B according to the invention were again irradiated with 1 mW/cm² of UV-A black light for a period of 3 hours. The contact angles measured subsequently to the irradiation procedure are specified in Table 3:

TABLE 3
Contact angle after renewed irradiation for 3 hours

| | Contact angle after |
|---|---|
| Roof tile | renewed irradiation for 3 h |
| Roof tile A acc. inv. | 6.7° |
| Roof tile B acc. inv. | 7.3° |

The data set forth in Table 1 show that the roof tiles according to the invention coated with TiO₂ particles have an extremely hydrophilic or superhydrophilic surface after irradiation with UV light. The hydrophilic properties worsen, which can be seen from an increase in the contact angle, if the roof tiles are stored in darkness over a prolonged period of time (see Table 2). It can be seen from Table 3 that the superhydrophilic property is restored again after just short-term irradiation with UV light which corresponds approximately to an hour in the Spring sunshine. Superhydrophilic surfaces can easily be cleaned with water, for example rain water.

In accordance with a preferred embodiment of the invention the contact angle of a 10 μl water drop on a coarse ceramic according to the invention without hydrophobic post-coating, after 15 hours of irradiation with 1 mW/cm² of UV-A black light, is preferably less than 6° to 7°, preferably less than 5°, further preferably less than 4°.

In accordance with a preferred embodiment of the invention the contact angle of a 10 μl water drop on a coarse ceramic according to the invention without hydrophobic post-coating, after 15 hours of irradiation with 1 mW/cm² of UV-A black light and 30 days of darkness, is preferably less than 20°, preferably less than 18°, further preferably less than 14°.

In accordance with a preferred embodiment of the invention the contact angle of a 10 μl water drop on a coarse ceramic according to the invention without hydrophobic post-coating, after 15 hours of irradiation with 1 mW/cm² of UV-A black light and 30 days of darkness and renewed irradiation with preferably 1 mW/cm² of UV-A black light for 3 hours, is less than 8°, preferably less than 7°.

In this respect photocatalytic activity can be determined in accordance with a number of methods.

1. Breakdown of Methanol to Formaldehyde

In this method the operation of determining photocatalytic activity is effected on the basis of the method described in GIT Labor-Fachzeitschrift 12/99, pages 1318 to 1320, wherein methanol is oxidised to give formaldehyde.

In this operation a material sample is taken from a roof tile and brought into contact with methanol. The material sample was irradiated for 7 minutes with UV light (high-pressure mercury lamp, Heraeus) at a wavelength of between 300 and 400 nm in order to catalyse the conversion of methanol to formaldehyde.

After the irradiation operation an aliquot was taken from the supernatant matter and mixed with 3-methylbenzothiazolin-2-one hydrazone hydrochloride hydrate (reaction solution) and shaken for 100 minutes at room temperature. After derivatisation of the formaldehyde with the dyestuff the concentration of the derivate was determined with a UV-VIS spectrometer (absorption bands at 635 nm), that is to say attenuation. Attenuation is a measurement in respect of photocatalytic activity of the sample body.

A blind measurement was conducted with a sample of an uncoated roof tile in order to exclude second-order effects such as breakdown reactions due to incorporated soiling or impurity substances.

All material samples have an identical reaction surface area. Calibration can be effected by comparative investigation of various material samples with the same reaction surface area and the same methanol concentration.

Forming the difference in respect of the measurement values obtained, that is to say the measurement value in respect of attenuation of the material sample with a particulate TiO₂ coating less the measurement value in respect of the comparative sample without a particulate TiO₂ coating gives a value which is a direct measurement in respect of photocatalytic activity of the material sample with the particulate TiO₂ coating.

For comparative purposes the coating Aktiv Clean was applied to a pane of glass using the Toto process. Attenuation of the reaction solution was between 0.085 and 0.109.

In accordance with a preferred embodiment of the invention the molded body according to the invention in the reaction solution results in an attenuation of between 0.020 and 0.500, preferably between 0.100 and 0.250, further preferably between 0.110 and 0.150.

2. Breakdown of Methylene Blue

This method of determining photocatalytic activity involves determining the breakdown rate of methylene blue in solution.

Firstly material samples of roof tiles are brought into contact with an adsorption solution of 0.02 mM methylene blue (in water) and the material samples treated in that way stored in darkness for 12 hours. The absorption spectra are measured prior to and after the 12-hour dark phase at a wavelength of 663 nm.

Thereafter the adsorption solution is replaced by a 0.01 mM methylene blue solution (in water) and the whole irradiated for 3 hours with 1 mW/cm² UV-A black light. The irradiated surface area is 10.75 cm² and the irradiated volume of the methylene blue solution is 30 ml. Over the irradiation period (3 hours) an aliquot was taken every 20 minutes and the absorption value determined at a wavelength of 663 nm. Using a calibration curve (absorption values of solutions with known methylene blue concentrations) it is possible to determine the breakdown rate of methylene blue (gradient of the measurement curve in a methylene blue concentration-versus-irradiation time graph).

By virtue of the large internal surface area of the roof tiles the material samples were constantly kept moist during the adsorption procedure and also during the irradiation procedure in order to avoid the methylene blue solutions being sucked up.

For comparative purposes the tests were conducted with uncoated material samples.

The photon efficiency ξ can be calculated from the photon flux (λ=350 nm; 10.75 cm² irradiated area; 1 mW/cm²) of 1.13×10⁻⁴ mol photon energy/h:

ξ[%]=breakdown rate (mol/h)/photon flux [mol photon energy/h].

A correction factor is subtracted from the value obtained in order to exclude adsorption effects. The correction factor is determined by a procedure whereby—after the 12 hour absorption time with the 0.02 mM methylene blue solution—the material sample is brought into contact for 3 hours with 0.01 mM methylene blue solution in darkness. At the end of that 3-hour incubation procedure the absorption value is determined at 663 nm, this being a measurement in respect of the breakdown of methylene blue by secondary reactions. That value represents the correction factor which converted into a notional photon efficiency is subtracted from the above-calculated photon efficiency.

In accordance with a preferred embodiment the photon efficiency—calculated from the photocatalytically induced methylene blue breakdown—in the case of the coarse ceramic according to the invention is at least 0.0150%, preferably at least 0.020%, further preferably at least 0.030%, still further preferably at least 0.040%.

3. Breakdown of Methyl Stearate

Taking material samples of roof tiles according to the invention and comparative tiles, a defined amount of a 10 mM methyl stearate/n-hexane solution was applied thereto and irradiation was effected for 17 hours at 1 mW/cm² UV-A black light.

After termination of the irradiation procedure the methyl stearate which has remained on the material samples was washed off with a defined volume of 5 ml of n-hexane and determined and quantified by means of gas chromatography (FID). The breakdown rate can be calculated in mol/h from that value.

In the case of a photon flux (λ=350 nm, 36 cm² irradiated surface area, 1 mW/cm²) of 3.78×10⁻⁴ mol photon energy/h, it is possible to calculate the photon efficiency ξ in connection with the ascertained breakdown rate, in accordance with methylene breakdown (see point 2 above). There is no need for correction of the values obtained as, in the case of the comparative sample material (roof tile without TiO₂ coating), no breakdown of methyl stearate took place.

In accordance with a preferred embodiment the photon efficiency—calculated from the photocatalytically induced methyl stearate breakdown—in the case of the coarse ceramic according to the invention is at least 0.05%, preferably at least 0.06%, further preferably at least 0.07%, still further preferably at least 0.08%, preferably 0.10%.

It has been found that the self-cleaning property of the surface can be markedly improved if the photocatalytically active, porous, oxide-ceramic coating is provided with a hydrophobic, preferably superhydrophobic surface. The oxidised organic soiling substances are still more easily flushed away from the surface by spraying or sprinkling with water.

In accordance with the invention the term hydrophobic surface is used to denote a surface which is generally water-repellent.

In accordance with a preferred development the coarse-ceramic molded body according to the invention has a superhydrophobic surface.

In accordance with the invention the term superhydrophobic surface is used to denote a surface with a contact or edge angle of at least 140° for water. The edge angle can be determined in conventional manner at a drop of water of a volume of 10 μl, which is put on to a surface.

Preferably the contact or edge angle is at least 150°, further preferably 160°, still further preferably at least 170°.

The photocatalytically active, porous, oxide-ceramic coating can be hydrophobised using one or more compounds with straight-chain and/or branched-chain aromatic and/or aliphatic hydrocarbon residues with functional groups, wherein the functional groups are selected from amine, thiol, a carboxyl group, alcohol, disulfide, aldehyde, sulfonate, ester, ether or mixtures thereof. Preferably silicone oil, amine oils, silicone resin, for example alkylpolysiloxanes, alkoxysiloxanes, alkali metal siliconates, alkaline earth siliconates, silane-siloxane mixtures, amino acids or mixtures thereof are used.

Preferably the coating can be formed from Ormoceres, polysiloxane, alkylsilane and/or fluorosilane, preferably mixed with SiO₂. The straight-chain and/or branched-chain hydrocarbon residues preferably comprise between 1 and 30 C-atoms, further preferably between 6 and 24 C-atoms, for example between 16 and 18 C-atoms.

Preferably a mixture of alkali metal siliconates and/or alkaline earth siliconates in water is applied, wherein alkali metal is selected from the group which consists of Li, Na, K and mixtures thereof. Alkaline earths are preferably selected from the group which consists of Be, Mg, Ca, Sr, Ba and mixtures thereof. Preferred levels of dilution of alkali metal or alkaline earth siliconate in relation to water are in the range of between 1:100 and 1:600 (by weight/by weight), while further preferred levels of dilution are between 1:250 and 1:350 (by weight/by weight).

To provide a superhydrophobic surface, a mixture of particles, for example SiO₂, and hydrophobising agent, for example fluorosilane, can be applied. That superhydrophobising effect extremely advantageously enhances the self-cleaning property of the molded body according to the invention.

In accordance with a further preferred embodiment the superhydrophobic surface has raised portions. Those raised portions can be produced when applying the hydrophobising agent by a procedure whereby particulate material is added to the hydrophobising agent and that mixture is subsequently applied to the photocatalytically active, porous, oxide-ceramic coating.

When the surface is hydrophobised with the above-specified hydrophobising agents, the temperature may not be raised above 300° C. as that can then involve thermal decomposition, which has already been mentioned above, of the hydrophobising agents.

Therefore in accordance with the invention hardening is effected by calcining only when no hydrophobic surface has yet been applied to the photocatalytically active, porous, oxide-ceramic coating. If polysiloxane were used as an adhesive and subsequently the molded body were hardened by calcining, the surface usually has to be hydrophobised once again if a hydrophobic surface is to be afforded on the photocatalytically active, porous, oxide-ceramic coating.

Preferably the coarse-ceramic molded body is in the form of a roof tile, a tile, a clinker brick or a facade wall.

In the production according to the invention of a coarse-ceramic molded body the photocatalytically active, oxide-ceramic powder used in step (a) is preferably in a nano-disperse form. In that respect the particle size range of the oxide-ceramic powder in a range of between 5 nm and about 100 nm, further preferably between about 10 nm and about 50 nm, has proven to be highly suitable.

To produce the coarse-ceramic molded body according to the invention a preferably homogenous suspension is produced from oxide-ceramic powder, inorganic stabilisation agent and a liquid phase, by mixing. That suspension can be applied in a desired layer thickness to the oxide-ceramic base material.

The suspension may be applied to the oxide-ceramic base material for example by pouring, brushing, spraying, flinging and so forth. It will be appreciated that the oxide-ceramic base material can also be dipped into the suspension.

Preferably the suspension is applied in such a layer thickness that, after the drying and/or calcining operation, the result obtained is a coarse-ceramic molded body with a photocatalytically active, porous, oxide-ceramic coating in a thickness of between 50 nm and about 50 μm, preferably between about 100 nm and about 1 μm.

In that respect the layer is formed not only in the pores or capillaries of the surface but also on the surface of the coarse-ceramic molded body. In that way it is possible in part to form layer thicknesses in respect of the oxide-ceramic coating, which are larger than the mean diameter of the pores or capillaries which are usually in a range of between 0.1 μm and 5 μm.

The oxide-ceramic base material may be a green body (uncalcined ceramic material) or a pre-calcined or calcined ceramic material. The oxide-ceramic base material preferably has a water absorption capability of >1%, preferably between 2 and 12%.

The inorganic stabilisation agent used in step (a) stabilises the photocatalytically active, oxide-ceramic powder particles in the suspension so that the photocatalytically active, oxide-ceramic powder particles do not precipitate.

Preferably the inorganic stabilisation agent used is SiO₂, SnO₂, γ-Al₂O₃, ZrO₂ or mixtures thereof.

The inorganic stabilisation agent reduces the tendency to agglomeration of the photocatalytically active, oxide-ceramic powder particles or particles in the suspension. That permits uniform application and distribution of the powder particles on the surface of an item of coarse ceramic or ceramic. By virtue of the reduced agglomerate formation, this ultimately involves an increased level of photocatalytic activity in respect of the coating after application to the oxide-ceramic base material.

Calcination of the layer produced in step (b) can be effected on the one hand by calcining the molded body in a calcining furnace or in a calcining chamber at a temperature of more than 300° C. to about 1100° C. In addition the calcining operation is preferably effected in a temperature range of between about 700° C. and about 1100° C.

The drying operation is effected at a substantially lower temperature than the calcining operation. Drying is usually effected in a temperature range of between 50° C. and 300° C., preferably between 80° C. and 100° C. In that temperature range an applied superhydrophobic coating is not broken down or destroyed.

With the optional use of adhesive in step (a) there is preferably added to the suspension polysiloxane which promotes adhesion of the oxide-ceramic powder to the oxide-ceramic base material. Besides its adhesive effect polysiloxane also results in hydrophobisation of the structure. In addition addition of adhesive such as for example polysiloxane also produces an increase in the viscosity of the suspension produced in step (a) of the process according to the invention. Accordingly an adjusting agent does not necessarily have to be added when adding adhesive to the suspension in step (a). The viscosity which is adjusted using adhesive can be sufficient so that in step (b) the suspension can be applied to the oxide-ceramic base material, to form a layer.

The liquid phase used is preferably aqueous solutions and/or water-containing solutions. In a further preferred feature water is used as the liquid phase.

In a further configuration of the process according to the invention particulate material can also be added to the suspension produced in step (a). In this alternative configuration of the process, the raised portions which are advantageous in regard to the self-cleaning effect of the surface and also the catalytically active, porous, oxide-ceramic coating are produced in one step.

In a coarse-ceramic molded body produced in accordance with this alternative configuration of the process, there is then not a separate layer structure consisting of a layer with raised portions and, arranged thereover, catalytically active, porous, oxide-ceramic coating. Rather, the raised portions produced using particulate material and the photocatalytically active, oxide-ceramic components are present in substantially mutually juxtaposed relationship or intimately mixed with each other.

Optionally a hydrophobising agent can then also be added to that suspension so that superhydrophobisation of the oxide-ceramic surface is effected in the same step in the process.

A superhydrophobisation effect is achieved if the surface is hydrophobised and at the same time includes raised portions and recesses which are produced for example by the addition of particulate material.

In this alternative form of the process the hardening operation can then be effected only by drying so that no thermal decomposition of the hydrophobic surface occurs.

It will be appreciated that it is also possible firstly for the above-mentioned particulate material to be applied to the oxide-ceramic base material to produce raised portions and for it to be fixed to the surface of the ceramic base material by means of adhesive and/or sintering, for that surface which is prepared in that way and which has raised portions to be provided with a photocatalytically active, porous, oxide-ceramic coating using the process according to the invention, and for a superhydrophobic surface optionally to be subsequently produced on the photocatalytically active coating.

The hydrophobising agents used are preferably inorganic-organic hybrid molecules such as for example siloxanes, in particular polysiloxanes. In addition Ormoceres, alkylsilanes and/or fluorosilanes have proven to be suitable as the hydrophobising agents.

It will be appreciated however that it is also possible to use other hydrophobising agents, for example alkali metal or alkaline earth siliconates, as specified hereinbefore by way of example.

The hydrophobising agents can be applied by a suitable process, for example spraying, pouring, flinging, sprinkling etc. For example, firstly a hydrophobising solution or suspension can be produced using a preferably aqueous liquid phase. Optionally particulate materials can also be added to that hydrophobising solution or suspension if raised portions are to be produced in the superhydrophobic surface. That hydrophobising solution or suspension can then be applied in the above-described conventional manner.

The term superhydrophobic surface is used in accordance with the invention to denote a superhydrophobic layer, wherein the edge angle for water is at least 140°, preferably 160°, further preferably 170°.

In addition, a pre-drying step can also be carried out after application of the suspension produced in step (a) to the oxide-ceramic base material, prior to the calcining operation. In that pre-drying step the liquid phase, preferably water, can be removed by evaporation. That can be effected for example by heating, for example in a circulating air furnace or a radiant furnace. It will be appreciated that it is also possible to use other drying processes, for example using microwave technology.

The pre-drying step has proven to be advantageous in order to avoid cracking or tearing of the layer produced from the suspension, in the calcining operation.

After the calcining operation a superhydrophobic surface can then be applied in the above-described manner.

In a preferred embodiment, after the calcining step and the optionally implemented hydrophobising operation, it is possible to carry out a post-treatment of the photocatalytically active, porous, oxide-ceramic coating produced. The post-treatment is effected by irradiation with laser light, or NIR or UV light. That post-treatment can improve the adhesion between the photocatalytically active coating and the oxide-ceramic base material.

It has been found that the coarse-ceramic molded body according to the invention, besides an improved self-cleaning property, also has improved mechanical stability. There is the very great advantage that the catalytically active, porous, oxide-ceramic coating with a possibly superhydrophobic surface adheres very firmly and reliably to and in the coarse-ceramic base material. Thus when that coating is applied for example to roof tiles it is not destroyed or abraded when a person walks on the roof. In particular the coating applied in the pores or the capillary structure is reliably protected from mechanical effects.

1. A ceramic molded body, more specifically a roof tile, tile, clinker brick, or a facade wall of oxide-ceramic base material with a capillary structure and with a surface which is self-cleaning upon spraying or sprinkling with water, characterized in that the molded body has a porous oxide-ceramic coating, wherein the coating is photocatalytically active and the photocatalytically active, oxide-ceramic materials include TiO₂, Al₂O₃ and SiO₂, wherein the Al₂O₃ is aluminum oxide C, and has a specific surface area in a range of between 25 mg²/g and 200 m²/g, preferably between 40 m²/g and 150 m²/g, wherein the mean diameter of the pores or the capillaries is in a range of between 0.1 μm and 5 μm.

2. A ceramic molded body as set forth in claim 1 characterized in that the pore openings are of an intergranular and/or intragranular nature.

3. A ceramic molded body as set forth in one of claims 1 and 2 characterized in that the free breathing cross-section of the ceramic molded body is reduced by the applied porous, oxide-ceramic coating by less than 10%, preferably less than 5%, with respect to the free breathing cross-section of an uncoated ceramic molded body.

4. A ceramic molded body as set forth in claim 1, characterized in that the porous, oxide-ceramic coating is applied to a depth of 1 mm, preferably to a depth of 2 mm, measured in a vertical direction from the surface of the ceramic molded body, in the ceramic molded body.

5. A ceramic molded body as set forth in claim 1, characterized in that the coating has a specific surface area in a range of between 40 m²/g and 100 m²/g.

6. A ceramic molded body as set forth in claim 1, in that the mean layer thickness of the coating is in a range of between 50 nm and 50 μm, preferably 100 nm and 1 μm.

7. A ceramic molded body as set forth in claim 1, characterized in that arranged between the oxide-ceramic base material and the photocatalytically active, porous, oxide-ceramic coating is at least one layer with raised portions, the oxide-ceramic base material has raised portions and/or the photocatalytically active, porous, oxide-ceramic coating is in the form of a layer with raised portions.

8. A ceramic molded body as set forth in claim 7 characterized in that the raised portions are formed by particulate material fixed to the oxide-ceramic base material.

9. A ceramic molded body as set forth in claim 8 characterized in that the particulate material is temperature-resistant ground material preferably selected from the group which consists of ground rock, fire clay, clay, minerals, ceramic powder such as SiC, glass, glass chamotte and mixtures thereof.

10. A ceramic molded body as set forth in claim 8 or claim 9 characterized in that the size of the particles and/or the raised portions is or are in a range of up to 1500 nm, preferably of between 5 nm and 700 nm, further preferably between 5 nm and 50 nm.

11. A ceramic molded body as set forth in claim 1, characterized in that the oxide-ceramic base material includes photocatalytically active, oxide-ceramic materials selected from the group which consists of TiO₂, Al₂O₃, SiO₂ and mixtures thereof.

12. A ceramic molded body as set forth in claim 1, characterized in that the photocatalytically active, oxide-ceramic material has an average particle size in the range of between 5 nm and 100 nm, preferably between 10 nm and 50 nm.

13. A ceramic molded body as set forth in claim 1, characterized in that the TiO₂ contained in the photocatalytically active, porous, oxide-ceramic coating and/or in the oxide-ceramic base material is present at least in part and preferably in respect of at least 40% by weight with respect to the total amount of TiO₂, in the anatase structure.

14. A ceramic molded body as set forth in claim 1, characterized in that the TiO₂ contained in the photocatalytically active, porous, oxide-ceramic coating and/or in the oxide-ceramic base material is present in respect of at least 70% by weight with respect to the total amount of TiO₂, in the anatase structure.

15. A ceramic molded body as set forth in claim 1, characterized in that the TiO₂ is present in a mixture comprising between 70 and 100% by weight of anatase and between 30 and 0% by weight of rutile.

16. A ceramic molded body as set forth in claim 1, characterized in that the TiO₂ is present in respect of about 100% by weight in the anatase structure.

17. A ceramic molded body as set forth in claim 1, characterized in that the contact angle of a 10 μl drop of water on the porous, oxide-ceramic coating without hydrophobic post-coating after 15 hours of irradiation with 1 mW/cm² UV-A black light is less than 7°, preferably less than 5°, further preferably less than 4°.

18. A ceramic molded body as set forth in claim 1, characterized in that the contact angle of a 10 μl drop of water on the porous, oxide-ceramic coating without hydrophobic post-coating after 15 hours of irradiation with 1 mW/cm² UV-A black light and 30 days in darkness is less than 20°, preferably less than 18°, further preferably less than 14°.

19. A ceramic molded body as set forth in claim 1, characterized in that the contact angle of a 10 μl drop of water on the porous, oxide-ceramic coating without hydrophobic post-coating after 15 hours of irradiation with 1 mW/cm² UV-A black light and 30 days in darkness and renewed irradiation with preferably 1 mW/cm2 UV-A black light for 3 hours is less than 8°, preferably less than 7°.

20. A ceramic molded body as set forth in claim 1, characterized in that the coating has a superhydrophobic surface, wherein the superhydrophobic surface has a contact or edge angle of at least 140° for water.

21. A ceramic molded body as set forth in claim 20 characterized in that the superhydrophobic surface is provided using one or more compounds having straight-chain or branched-chain aromatic and/or aliphatic hydrocarbon residues with functional groups, wherein the functional groups are selected from amine, thiol, a carboxyl group, alcohol, disulfide, aldehyde, sulfonate, ester, ether or mixtures thereof.

22. A ceramic molded body as set forth in claim 21 characterized in that the superhydrophobic surface is produced using compounds selected from the group which consists of silicone oil, amine oils, silicone resin, for example alkylpolysiloxanes, alkoxysiloxanes, alkali metal siliconates, alkaline earth siliconates, silane-siloxane mixtures, amino acids and mixtures thereof.

23. A ceramic molded body as set forth in claim 20 characterized in that the superhydrophobic surface of the coating is produced using Ormoceres, polysiloxane, alkylsilane and/or fluorosilane, preferably in combination with SiO₂.

24. A ceramic molded body as set forth in claim 20 characterized in that the superhydrophobic surface is applied using a solution of alkali metal siliconates in water, wherein alkali metal is selected from the group which consists of lithium, sodium, potassium and mixtures thereof.

25. A ceramic molded body as set forth in one of claims 20 through 24 characterized in that the superhydrophobic surface has a contact or edge angle of at least 150° for water, preferably at least 160°, still further preferably at least 170°.

26. A ceramic molded body as set forth in claim 25 characterized in that the solution of alkali metal siliconates in water has a dilution ratio of between 1:100 and 1:600 (by weight/by weight), preferably a dilution ratio of between 1:250 and 1:350 (by weight/by weight).

27. A ceramic molded body as set forth in one of claims 20 through 26 characterized in that the superhydrophobic surface of the coating has raised portions.

28. A ceramic molded body as set forth in claim 27 characterized in that the raised portions of the superhydrophobic surface are produced using particulate material.

29. A ceramic molded body as set forth in claim 20 characterized in that the superhydrophobic surface is applied using a mixture of particles, for example SiO₂, and hydrophobising agent, for example fluorosilane.

30. A ceramic molded body as set forth in claim 1, characterized in that the photoefficiency calculated from photocatalytically induced methylene blue breakdown in the case of the porous, oxide-ceramic coating is at least 0.015%, preferably at least 0.02%, further preferably at least 0.03%, still further preferably at least 0.04%.

31. A process for the production of a coarse-ceramic molded body, more specifically a roof tile, tile, clinker brick or a facade wall of oxide-ceramic base material with a capillary structure and with a surface which is self-cleaning upon spraying or sprinkling with water, wherein the molded body has a photocatalytically active, porous, oxide-ceramic coating which includes the photocatalytically active, oxide-ceramic materials TiO₂, Al₂O₃ and SiO₂, wherein the Al₂O₃ is aluminum oxide C, with a specific surface area in a range of between 25 m²/g and 200 m²/g, preferably 40 m²/g and 150 m²/g, wherein the mean diameter of the pores or the capillaries is in a range of between 0.1 μm and 5 μm, and the porous oxide-ceramic coating is disposed on the surface and in the pore openings and the free faces of the capillary structure to a depth of 2 mm, measured in a vertical direction from the surface of the ceramic molded body, in the coarse-ceramic molded body,
wherein the process includes the following steps:
(a) mixing photocatalytically active, oxide-ceramic powder which includes TiO₂, Al₂O₃ and SiO₂, wherein the Al₂O₃ is aluminum oxide C, and a liquid phase to afford a suspension,
(b) applying the suspension produced in step (a) to the oxide-ceramic base material to produce a layer, and
(c) hardening the layer afforded in step (b) to produce a photocatalytically active, porous, oxide-ceramic coating.

32. A process as set forth in claim 31 characterized in that at least one layer with raised portions is applied to the oxide-ceramic base material in a preceding step and the suspension produced in step (a) is applied to the oxide-ceramic base material provided with a layer with raised portions and subsequently hardened in step (c).

33. A process as set forth in one of claims 31 and 32 characterized in that particulate material is additionally added in step (a).

34. A process as set forth in claim 33, characterized in that raised portions are formed by fixing particulate material on the oxide-ceramic base material.

35. A process as set forth in claim 33, characterized in that the particulate material is temperature-resistant ground material preferably selected from the group which consists of ground rock, fire clay, clay, minerals, ceramic powder such as SiC, glass, glass chamotte and mixtures thereof.

36. A process as set forth in claim 33, characterized in that the mean particle size of the particulate material is in a range of up to about 1500 nm, preferably between 5 nm and 700 nm, further preferably between 5 nm and 50 nm.

37. A process as set forth in claim 31, characterized in that polysiloxane is added to the suspension in step (a).

38. A process as set forth in claim 31, characterized in that water or an aqueous or water-bearing medium is used as the liquid phase in step (a).

39. A process as set forth in claim 31, characterized in that the adhesion between the catalytically active coating and the oxide-ceramic base material is improved by a procedure whereby the photocatalytically active, porous, oxide-ceramic coating produced in step (c) is irradiated with laser light or NIR or UV light.

40. A process as set forth in claim 31, characterized in that contained in the oxide-ceramic base material of the molded body are photocatalytically active, oxide-ceramic materials selected from the group which consists of TiO₂, Al₂O₃, SiO₂ and mixtures thereof.

41. A process as set forth in claim 31, characterized in that the photocatalytically active, oxide-ceramic powder used in step (a) includes particles in the range of between about 5 nm and about 100 nm, preferably between about 10 nm and about 50 nm.

42. A process as set forth in claim 31, characterized in that the TiO₂ contained in the photocatalytically active, oxide-ceramic powder and/or in the oxide-ceramic base material is present at least in part and preferably in respect of at least 40% by weight with respect to the total amount of TiO₂ in the anatase structure.

43. A process as set forth in claim 31, characterized in that the TiO₂ contained in the photocatalytically active, oxide-ceramic powder and/or in the oxide-ceramic base material is present in respect of between at least 70% and 100% by weight with respect to the total amount of TiO₂ in the anatase structure.

44. A process as set forth in claim 31, characterized in that the TiO₂ contained in the photocatalytically active, oxide-ceramic powder and/or in the oxide-ceramic base material is present in a mixture comprising between 70 and 100% by weight of anatase and between 30 and 0% by weight of rutile.

45. A process as set forth in claim 31, characterized in that the TiO₂ contained in the photocatalytically active, oxide-ceramic powder and/or in the oxide-ceramic base material is present in respect of about 100% by weight with respect to the total amount of TiO₂ in the anatase structure.

46. A process as set forth in claim 31, characterized in that the layer produced in step (b) is hardened in step (c) by drying at a temperature of up to 300° C. and/or by calcining at a temperature of more than 300° C. to 1100° C.

47. A process as set forth in claim 46 characterized in that the layer produced in step (b) is at least partially pre-dried prior to the calcining operation in step (c) by evaporation of the liquid phase.

48. A process as set forth in claim 31, characterized in that the coating hardened in step (c) is hydrophobised or superhydrophobised to provide a hydrophobic surface.

49. A process as set forth in claim 31, characterized in that a hydrophobising agent is additionally added in step (a) and the coating produced in step (b) is hardened in step (c) by drying at a temperature of up to 300° C.

50. A process as set forth in claim 48 characterized in that an inorganic-organic hybrid molecule, preferably a polysiloxane solution or an alkali metal or alkaline earth siliconate solution is used for hydrophobisation.

51. A process as set forth in claim 48 characterized in that the superhydrophobic surface is provided using one or more compounds having straight-chain or branched-chain aromatic and/or aliphatic hydrocarbon residues with functional groups, wherein the functional groups are selected from amine, thiol, a carboxyl group, alcohol, disulfide, aldehyde, sulfonate, ester, ether or mixtures thereof.

52. A process as set forth in claim 51 characterized in that the superhydrophobic surface is produced using compounds selected from the group which consists of silicone oil, amine oils, silicone resin, for example alkylpolysiloxanes, alkoxysiloxanes, alkali metal siliconates, alkaline earth siliconate, silane-siloxane mixtures, amino acids and mixtures thereof.

53. A process as set forth in claim 48 characterized in that the superhydrophobic surface of the coating is produced using Ormoceres, polysiloxane, alkylsilane and/or fluorosilane, preferably in a mixture with SiO₂.

54. A process as set forth in one of claims 48 through 53 characterized in that particulate material is added to produce a superhydrophobic surface with raised portions in the hydrophobisation operation.
